(19) United States
(12) Patent Application Publication
(10) Pub. No.: US 2009/0066613 A1
(43) Pub. Date: Mar. 12, 2009

(54) DISPLAY APPARATUS

(75) Inventors: Kohichi Nakamura, Kanagawa-ken (JP); Somei Kawasaki, Saitama-ken (JP); Masami Iseki, Kanagawa-ken (JP); Fujio Kawano, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku, Tokyo (JP)

(21) Appl. No.: 11/721,140

(22) PCT Filed: Oct. 11, 2006
(86) PCT No.: PCT/JP06/20684

§ 371 Date: Jun. 7, 2007

(30) Foreign Application Priority Data
Oct. 12, 2005 (JP) 2005-297639

(51) Int. Cl. G09G 3/32

(52) U.S. Cl. 345/76

(57) ABSTRACT

A display apparatus of the present invention has EL elements and pixel circuits 2 for supplying currents to the EL elements, which are arranged in a matrix fashion, and column control circuits 1 arranged corresponding to the number of columns of the matrix. The same number of column control circuits 1 and data lines 14 form a group, and the data line 14 which becomes an output of the column control circuit 1 is sequentially changed over in the group. Furthermore, the display apparatus includes means for correcting input signals among different groups. According to the present invention, even if a characteristic of the column control circuit 1 has a variation, no unevenness occurs in a displayed image.

### TECHNICAL FIELD

The present invention relates to a display apparatus, and more particularly to a display apparatus in which electroluminescence (EL) elements, which emit light depending on an inputted current, are arranged in a matrix fashion.

### BACKGROUND ART

In recent years, a self-light-emitting type display using a light emitting element and the like have been drawn attention as a next generation display. Among those, an applied development of an organic electroluminescence element which is the light emitting element of a current control type, in which a light emitting luminance is controlled by a current flown to the element, has been actively performed.

In an organic EL display in which a display element and a peripheral circuit are mounted on one panel, a thin film transistor (TFT) is used not only in a display region but also in the peripheral circuit. Although the TFT has an advantage that it can be formed on a substrate such as glass at low temperature, on the other hand, the TFT has a problem that element characteristics such as a threshold voltage, an ON-state resistance and the like vary widely.

In order that, when there is a variation in a threshold of the TFT configuring a circuit of the display region, the EL may be driven with a predetermined current without being affected by the variation, several circuit methods have been proposed. In U.S. Pat. No. 6,373,454, there has been proposed a current programming method for converting a video signal into a current signal and supplying the current signal to a data line, and then storing the current signal as a voltage value in a capacitor provided at a pixel.

In the current programming method, a circuit for sampling the video signal and generating the current signal is provided for each column at the periphery of the display region. Since the peripheral circuit is also configured with the TFT, even among the TFTs provided at adjacent positions, there are variations in the threshold, a carrier mobility and the like. Thus, there is also a variation in a voltage-current conversion gain among the current generation circuits provided for the respective columns, and accordingly, a variation in a luminance occurs for each column and the variation becomes visible as a stripe unevenness in a column direction.

In order to delete a luminance unevenness due to a characteristic variation in the current generation circuits among the columns, there has been proposed a method for changing over and using a circuit for supplying a current to one data line, sequentially among a plurality of current generation circuits, in U.S. Pat. No. 5,933,033. By changing over the current generation circuits at high speed, the variation is averaged temporally and made to be invisible.

Moreover, in a method proposed in U.S. Patent Publication No. 2004-0183752, the luminance variation is reduced by detecting a current signal supplied to a data line, comparing it with reference current data, and with their deviance as a factor, correcting a video signal.

However, in the method of changing over sequentially and temporally averaging the current generation circuits, a switch circuit is required for changing over, and the more the number of the current generation circuits to be changed over increases, the more complex the circuits become. Thus, the current generation circuits to be changed over and used are limited to at most several circuits, and even if the averaging is performed in a group of these several circuits, the variation still remains between the group and other groups. This variation in current values among the groups also becomes visible as the luminance unevenness.

Moreover, in the method of detecting the current data and correcting the video signal, in order to detect its output current for each one of the current generation circuits, a high-precision current detection circuit is required, and also it takes too much time to detect in a short period in an interval of a display period, such as a vertical retrace time and the like.

### DISCLOSURE OF THE INVENTION

It is an object of the present invention to provide a display apparatus for reducing a variation in current signals supplied from column current generation circuits of respective columns to pixel circuits and reducing a luminance variation, in an active matrix apparatus using current driven type light emitting elements, such as EL elements.

In order to achieve the above described object, the display apparatus according to the present invention is characterized by including:

a matrix display area in which display elements and pixel circuits for driving the above described display elements are arranged in a row direction and a column direction;

a row control circuit provided for each row of the above described matrix display area, for selecting the above described pixel circuit at the above described row;

a column control circuit provided for each column of the above described matrix display area, for generating and outputting a current data signal depending on an input signal; and

a data line provided for each column of the above described matrix display area, for conveying the above described current data signal outputted from the above described column control circuit, to the pixel circuit selected by the above described row control circuit,

wherein the above described column control circuit and the above described data line configures a plurality of groups having the same number of column control circuits and data lines as one group, and the above described display apparatus further includes:

a connection changing switch provided for each of the above described groups, for connecting the above described column control circuits and the above described data lines in the above described group in a one-to-one manner in which they can be changed over; and

correction means for correcting an inputted video signal for each group of the above described column control circuits and making the video signal as the input signal of the above described column control circuit.

The above described correction means preferably includes:

an open and close switch for branching a current path from the above described column control circuit to the above described data line and connecting the current path to a terminal which is common to all columns;

a current detection circuit connected to the above described terminal which is common to all columns, for detecting a sum of currents outputted from the above described column control circuits; and

a correction circuit for correcting the above described video signal based on an output from the above described current detection circuit.

In a further preferable embodiment, operations are performed, the operations including:

turning off the above described connection changing switch and turning on the above described open and close switch in a non-display period in which the above described row control circuit does not select the pixel circuit at any row, and for each of the above described groups, inputting the input signal for distinguishing the above described group from other groups into the above described column control circuits and also detecting the sum of the currents by the above described current detection circuit; and

turning on the above described connection changing switch and turning off the above described open and close switch in a display period in which the above described row control circuit has selected the pixel circuit at any row, and based on the sum of the currents detected for each of the above described groups in the above described non-display period, correcting the above described video signal by the above described correction circuit.

According to the present invention, since the column control circuit for supplying the current data signal to the data line has been configured to be changed over sequentially in a predetermined group for supplying to the pixel circuit, it is possible to temporally average the variation in the current data signals supplied to the pixel circuits in the group.

In addition, by modulating the video signal and correcting the variation among different groups, it is possible to mitigate visual problems such as an unevenness, a stripe and the like in the display apparatus.

### BRIEF DESCRIPTION OF THE DRAWINGS

FIG. 1 is a diagram showing an overall configuration of a display apparatus according to an embodiment of the present invention;

FIG. 2 is a diagram showing a configuration example of column control circuits and a connection changing switch of the present invention;

FIG. 3 is a timing chart of control signals of the circuits shown in FIG. 2;

FIG. 4 is a timing chart showing interchange of video signals of the present invention;

FIG. 5 is a variation example of the column control circuits and the connection changing switch of the present invention;

FIG. 6 is a diagram showing a configuration of a pixel circuit;

FIG. 7 is a diagram showing a configuration of the column control circuit; and

FIG. 8 is a block diagram showing a configuration of a digital still camera using the display apparatus of the present invention.

### BEST MODE FOR CARRYING OUT THE INVENTION

Hereinafter the best mode for carrying out a display apparatus according to the present invention will be described specifically, with reference to the drawings. This embodiment has been applied to an active matrix type display apparatus using EL elements.

### 1. Configuration of the Display Apparatus

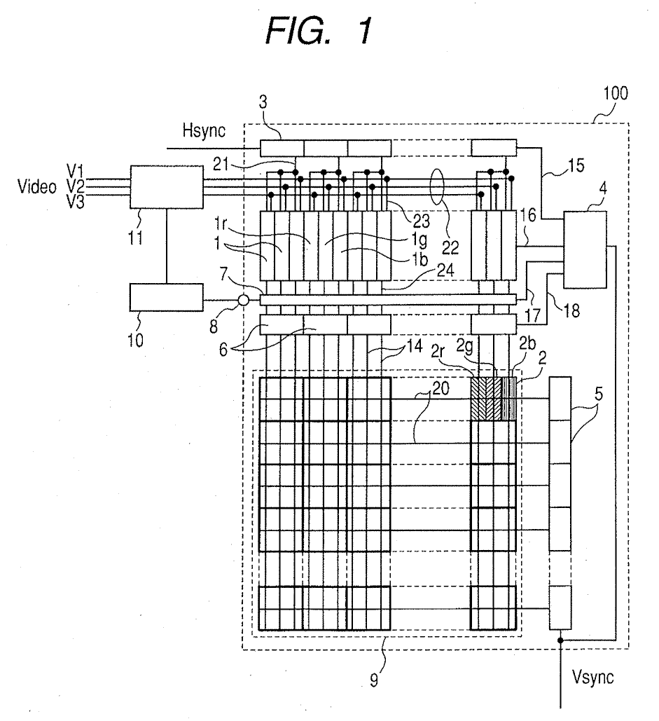

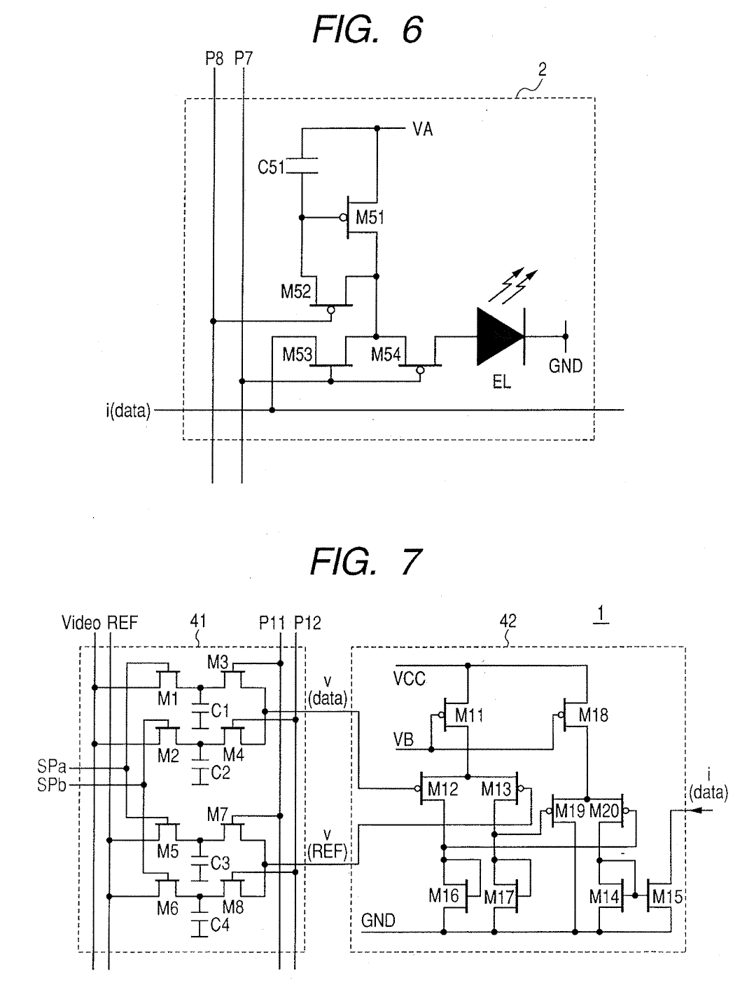

FIG. 1 shows an overall configuration of the display apparatus of this embodiment. In a display apparatus 100, EL display elements (not shown) and pixel circuits 2 for driving the EL elements are arranged in a row direction and a column direction to configure a matrix display area 9. In FIG. 1, each pixel circuit 2 has driving circuits 2r, 2g and 2b of the EL display elements of three colors of red, green and blue (hereinafter abbreviated as “RGB”) as one group. A specific configuration of the pixel circuit 2 is illustrated in FIG. 6. FIG. 6 will be described below.

In the matrix display area 9, scan lines 20 are provided for respective rows and data lines 14 are provided for respective columns. Furthermore, at the periphery of the display area 9, a set of row control circuits 5 provided for the respective rows, for outputting scan signals to the scan lines 20, and a set of column control circuits 1 provided for the respective columns, for outputting current data signals to the data lines 14 depending on input signals are arranged.

The row control circuits 5, as a whole, configure a shift register for performing a shift operation with a vertical sync signal Vsync, and send a selection pulse sequentially to the scan line to select a row. Although the selection of the scan line may be one by one sequentially from above, an interlace scan may be performed for selecting only every other odd line and selecting only an even line at the next vertical synchronization. In the case of the interlace, two sequences of shift registers may be provided and changed over alternately for each vertical synchronization.

As peripheral circuits at the side of the columns, in addition to the column control circuits 1, there are provided horizontal shift registers 3, connection changing switches 6 and an open and close switch 7, a gate circuit 4 for providing a control signal to these, a current detection circuit 10 for detecting a current outputted to a common terminal 8 when the open and close switch 7 is turned on, and a correction circuit 11 for correcting a video signal Video based on the detected current. The matrix display area 9 and the above described peripheral circuits are configured with the TFTs, and formed integrally on one substrate. However, since the current detection circuit 10 and the correction circuit 11 are configured with ICs and individual circuit parts, they are provided separately from the substrate on which the matrix area 9 and a set of the peripheral circuits have been formed.

The horizontal shift register 3 performs the shift operation with a horizontal sync signal Hsync, and puts each three of the column control circuits 1 together to supplies them with a sampling pulse 21 sequentially. The three column control circuits 1 which receive the same sampling pulse 21 is a group for issuing RGB three colors data for respective colors of light emitting elements.

The video signal Video inputted from outside goes through the correction circuit 11 to enter the column control circuits 1. The video signal Video consists of three parallel signals V1 to V3. A video signal 22, after it has gone through the correction circuit 11, also consists of three parallel signals. One of these three parallel signals enters each of the column control circuits 1 as an input signal 23.

Since the signals V1 to V3 are serial signals of video data respectively, the column control circuits 1 sample these three signals as one group sequentially. A timing of the sampling is determined with the sampling pulse 21 outputted from the horizontal shift register 3. One group of column control circuits of RGB 1r, 1g and 1b samples the video signals V1 to V3 simultaneously.

The column control circuit 1 issues corresponding current data from the input signal 23, and outputs it from an output terminal 24 with a control signal 16 synchronized with the row selection by the row control circuit 5. The outputted current data signal is supplied via the connection changing switch 6, which will be described below, to the data line 14, or via the open and close switch 7 to the common terminal 8.

### 2. Configuration of the Column Control Circuit

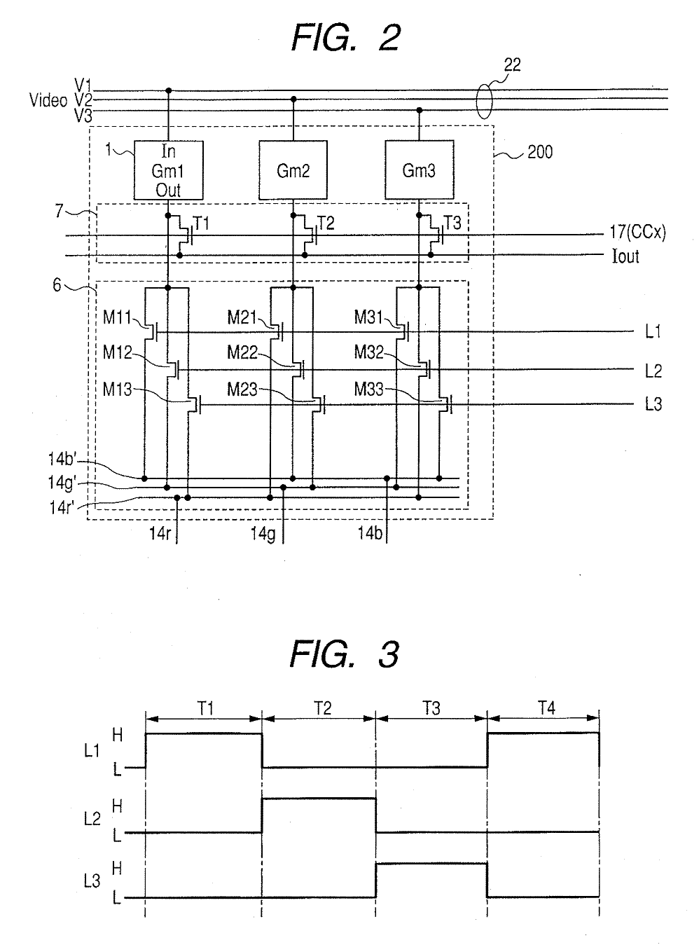

FIG. 2 is a diagram showing a configuration of the column control circuits 1, the connection changing switch 6 and the open and close switch 7 in this embodiment.

The column control circuit 1 (Gm1, Gm2 and Gm3) receives any of the input signals V1 to V3 at an input end In and issues the current data signal from an output end Out. Outputs of Gm1, Gm2 and Gm3 branch into three respectively, and connected to drains of respective columns M11 to M13, M21 to M23 and M31 to M33 of a TFT matrix configuring the connection changing switch 6, respectively.

The connection changing switch 6 is configured with 9 TFTs of M11 to M33, and wirings 14r′, 14g′ and 14b′ in which data lines 14r, 14b and 14g have been extended. As will be described next, the TFT matrix serves as switches individually to connect each of the column control circuits 1 (Gm1, Gm2 and Gm3) with each of the data lines 14 (R column, G column and B column) in a one-to-one manner in which they can be changed over.

In three columns of the TFT matrix {M11-M13}, {M21-M23} and {M31-M33}, their respective drain terminals are connected to output terminals of Gm1, Gm2 and Gm3, and their respective gate terminals are connected to control lines L1, L2 and L3, in common with the gate terminals of the corresponding TFT of other groups.

Source terminals are connected to the three wirings 14r′, 14g′ and 14b′. In an example of FIG. 2, the source terminals of the TFT columns {M11, M12 and M13} connected to the output terminal of the first column control circuit Gm1 are connected to 14b′, 14g′ and 14r′, respectively. The source terminals of the TFTs {M21, M22 and M23} connected to the output terminal of the second column control circuit Gm2 are connected to 14r′, 14b′ and 14g′, respectively. The drain terminals of the TFTs {M31, M32 and M33} connected to the output terminal of the third column control circuit Gm3 are connected to 14g′, 14r′ and 14b′, respectively.

These connections allocate the source terminals of the three TFTs of each column to the three data lines. When the source terminals of one column are attached with signs (1 2 3), the data lines are attached with signs (r=1 g=2 b=3), and the connections are expressed as follows:

$$\begin{matrix}Source terminals & ( 1 & 2 & 3 ) \\ & ↓ & ↓ & ↓ \\ Data lines & ( p & q & r ) ,\end{matrix}$$

this is considered as a permutation from (1 2 3) into (p q r), and hereinafter this permutation will be written as (p q r). There are the same number of allocation patterns as the number of permutations (3!=6). Three of these allocation patterns may be selected and applied to the TFTs of the first column, the second column and the third column respectively, to make wire connections. FIG. 2 shows an example of selecting three cyclic permutations of (2 3 1), (1 2 3) and (3 1 2).

The selection of the three permutations must not include the same wire connection in comparison of two of them. For example, if the same wire connection is included such as (1 2 3), (1 3 2) and (2 3 1) (there is the same connection of 1 to 1 in the first and second permutations, and also, there is the same connection of 2 to 3 in the second and third permutations), two column control circuits are connected to one data line simultaneously, and such a selection must be avoided.

The open and close switch 7 includes the TFTs (T11 to TN, N is the number of the columns), each one of which is provided at each output end of the column control circuit 1, a common current line Iout connecting their source terminals commonly for all of the columns, and a control line 17 (CCx) for controlling the gate terminals also commonly for all of the columns. The common current line Iout is connected to the common terminal 8 at an end of a display panel.

It should be noted that as to a group of circuits 200 surrounded by a dotted line in FIG. 2, there are a plurality of such groups which are repeated in a lateral direction, although not shown in FIG. 2. The first group of circuits 200 is connected to the three data lines 14 (R column 14r, G column 14g and B column 14b) to supply the current data to three pixels R, G and B of the first to third columns, the next group of circuits 200 supplies the current data to the pixels of the fourth to sixth columns, and after that, similarly the each group supplies the current data to the corresponding columns.

### 3. Operation of the Connection Changing Switch

Hereinafter an operation of the connection changing switch 6 will be described based on FIG. 2. It is assumed that T1 to TN are all off, and the open and close switch 7 has been turned off.

To the respective input ends of Gm1, Gm2 and Gm3, V1 to V3 of the video signal Video are connected respectively via the correction circuit. To signal lines 22 of V1 to V3, the video signals of RGB are periodically changed over and transmitted by an external circuit which is not shown. This changing will be described below.

Among three gate control lines of the TFT matrix, L1 is connected to the gate terminals of M11, M21 and M31, L2 is connected to the gate terminals of M12, M22 and M32, and L3 is connected to the gate terminals of M13, M23 and M33, respectively.

L1, L2 and L3 are ON/OFF control signals 18 which have been transmitted from the gate circuit 4. This controls open and close of the respective switches (M11 and others) of the TFT matrix. FIG. 3 shows a timing chart of the control signals L1 to L3.

As shown in FIG. 3, L1 to L3 synchronize with the horizontal sync signal Hsync to become H level in only one period of T1 to T3, and take L level in other periods. This is repeated in three horizontal cycles. At this point, the connection changing switch 6 performs the operation shown in Table 1. In Table 1, “No.” column shows a horizontal sync number, “ON-TFT” column shows the TFTs which become ON state in that period, and columns of Gm1 to 3 show the respective data lines to which they are connected.

TABLE 1

| No. | L1 | L2 | L3 | ON-TFT | Gm1 | Gm2 | Gm3 |
|---|---|---|---|---|---|---|---|
| T1 | H | L | L | M11, M21, M31 | 14b | 14r | 14g |
| T2 | L | H | L | M12, M22, M32 | 14g | 14b | 14r |
| T3 | L | L | H | M13, M23, M33 | 14r | 14g | 14b |

First, in a first horizontal line cycle T1, a High level signal is inputted only to L1, and Low level signals are inputted to L2 and L3. At this point, only transistors of M11, M21 and M31 of the connection changing switch 6 become ON, and other transistors are OFF. In this state, Gm1 to Gm3 are connected to the wirings 14b, 14r and 14g, respectively.

In a second unit horizontal line cycle T2, the High level is inputted only to L2, and the Low level signals are inputted to L1 and L3. At this point, only transistors of M12, M22 and M32 of the connection changing switch 6 become ON, and other transistors are OFF. In this state, Gm1 to Gm3 are connected to the wirings 14g, 14b and 14, respectively.

In a third unit horizontal line cycle T3, the High level is inputted only to L3, and the Low level signals are inputted to L1 and L2. At this point, only transistors of M13, M23 and M33 of the connection changing switch 6 become ON, and other transistors are OFF. In this state, Gm1 to 3 are connected to the 14r, 14g and 14b, respectively.

In a fourth cycle T4, the similar operation as the first cycle T1 is performed, and after that, the similar operation as above is repeatedly executed. When this is expressed as follows:

$$\begin{matrix}Column control circuits & ( Gm 1 & Gm 2 & Gm 3 ) \\ & ↓ & ↓ & ↓ \\ Data lines & ( p 1 & p 2 & p 3 ) ,\end{matrix}$$

a permutation for expressing the connections of the column control circuits (Gm1 to 3) and the data lines (14r, 14g and 14b) becomes (3 1 2) in the period T1, (2 3 1) in the period T2 and (1 2 3) in the period T3.

As described above, by the connection changing switch 6, the outputs of Gm1 to Gm3 of the column control circuits 1 are sequentially changed over and supplied to the respective data lines of R column, G column and B column. Accordingly, even if there is a variation in current outputs of Gm1, Gm2 and Gm3, current signals supplied to the data lines are temporally averaged, and a visible luminance variation becomes small.

In this changing, the connections of the three column control circuits and the data lines are preferably performed without bias. If a particular same connection is included more than other connections, the bias occurs and the averaging becomes imperfect.

The connection changing switch 6 of this embodiment is configured with the TFTs in a matrix configuration. In other words, one column of the TFTs is arranged in each column control circuit to connect the drain terminal commonly to the output end of the column control circuit and to connect the source terminal to each data line, while the corresponding gate terminal of each column is connected by the control line commonly for all of the columns. At this point, the respective outputs of the column control circuit 1 are sequentially changed over and outputted to the three source terminals of the respective columns of the TFT matrix. Therefore, when the source terminals and the data lines 14r, 14g and 14b are connected as a cyclic permutation set, the connections of Gm1, Gm2 and Gm3 and the data lines also become cyclic in one cycle of the changing operation as described above. Accordingly, with respect to one data line, all of the column control circuits in that group will be changed over equally and connected, thereby a perfect averaging is performed without bias.

In the above description, although the changing of the switches has been performed in the horizontal line cycles, its speed is enough if it is not felt as flicker, and the changing of the switches also may be performed in cycles of the vertical sync signal Vsync.

Moreover, the changing of the data lines is not limited to that having three lines of the column control circuits and the data lines as one group. If six column control circuits and six data lines are put together in one group, there are 6! patterns of connections. However, it is not necessary to go through all of these connection patterns, and in order to perform the averaging of the column control circuits, one connection may be selected just one time. Therefore, no matter how many lines one group has, it is sufficient if they are averaged only with the cyclic permutations of them.

### 4. Interchange of Input Video Signals

When the changing of the connections of the column control circuits and the data lines is performed as described above, the input signals of the column control circuits have to be changed over, in order that the signals of the same color may be supplied to the corresponding data line.

By nature, the video signal is the parallel signals in which the respective signals of RGB are transmitted through three lines. If this is directly inputted into the display apparatus 100, the signal which is supplied to the data line 14 by the connection changing switch 6 does not correspond to the color of the above described data line. Thus, in the video signal Video inputted from the external circuit, which is not shown, into this display apparatus, a process of interchanging the data among the parallel signals of RGB has to be performed previously in accordance with the changing of the connection changing switch. This interchange is performed so that each of original video signals of RGB may be supplied constantly to the column of the light emitting elements of its color via the data line, with the connections of the column control circuits 1 and the data lines 14 by the connection changing switch 6. Since this is such an interchange in which the connections of the column control circuits 1 and the data lines 20 by the connection changing switch 6 are returned to the original connections, for example, when the connections by the connection changing switch 6 correspond to the permutation of (3 1 2), the interchange corresponding to its inverse permutation (2 3 1) is performed.

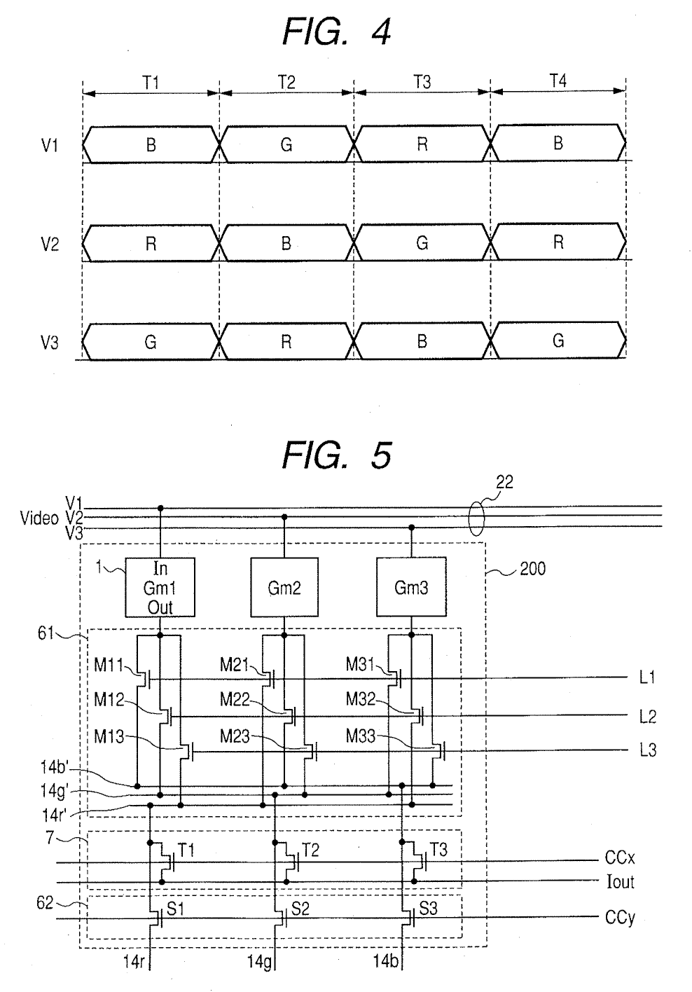

FIG. 4 shows an example of the changing of the video signals. T1 to T4 of FIG. 4 are the same periods as T1 to T4 of FIG. 3. In the period T1, since Gm1, Gm2 and Gm3 are connected to 14b, 14r and 14g respectively, in order that the video signals of R, G and B may be correctly transmitted to 14r, 14g and 14b, it is appropriate if the video signal of R has been transmitted to the line of V2, the video signal of G has been transmitted to the line of V3, and the video signal of B has been transmitted to the line of V1, respectively. In the period of T2, they are interchanged such that R is transmitted to V3, G is transmitted to V1 and B is transmitted to V2. In the period of T3, they are interchanged such that R is transmitted to V1, G is transmitted to V2 and B is transmitted to V3. From T4 and after that, T1 to 3 are repeated.

Hereafter, numbers are assigned to the video signals of RGB as R=1, G=2 and B=3 and to the signal lines of V1, V2 and V3 as V1=1, V2=2 and V3=3. When the respective video signals and the signal lines to which the video signals are transmitted have a relation as follows:

$$\begin{matrix}Video signals & ( 1 & 2 & 3 ) \\ & ↓ & ↓ & ↓ \\ Video signal lines & ( P & Q & R ) ,\end{matrix}$$

it is possible to have this relation correspond to a permutation (P Q R). In the example shown in FIG. 4, this permutation is expressed as (2 3 1) in T1 period, (3 1 2) in T2 period and (1 2 3) in T3 period. If this permutation is multiplied by the permutation of the connections between the column control circuits and the data lines as shown above, that is, the permutation of (3 1 2) in the period T1, (2 3 1) in the period T2 and (1 2 3) in the period T3, this permutation becomes as follows:

(2 3 1)*(3 1 2)=(1 2 3) in the period T1;

(3 1 2)*(2 3 1)=(1 2 3) in the period T2; and

(1 2 3)*(1 2 3)=(1 2 3) in the period T3,

which has become an inverse permutation relation. This relation ensures that each of the video signals of RGB is transmitted as the current data to the data line corresponding to its color.

When the original video signal is three parallel video signals, and the number of the data lines which belong to one group is 6, since a time division signal is transmitted at two times, the column control circuit inputs those signals by two samplings at each time. In this case, the interchange may be performed in the above described inverse permutation relation, including an interchange of temporally before and after. It is assumed that such a changing process has been previously performed on the input video signal Video in this embodiment.

When the number of the columns included in one group is large, not only the averaging in that group is performed, but also a variation among the columns becomes small. However, if the number of the columns is increased, the number of the TFTs of the connection changing switch increases and the connection changing switch becomes complex, which is not preferable.

In this way, since there is an upper limit in the number of the columns configuring one group, the current variation between one group and another group is not completely resolved. In this embodiment, the variation among the groups is resolved by combining with correction means as will be described below.

### 5. Correction Means

In this embodiment, a method of detecting the current outputs of the column control circuits, and based on its result, correcting the video signal will be described. The correction means in this case is configured with the open and close switch 7, the current detection circuit 10 and the correction circuit 11 of FIG. 1. Its operation will be described below.

As shown in FIG. 2, the open and close switch 7 is connected to the output terminals of the column control circuits 1 at one end, and to the common terminal 8 at the other end. The control line 17 (CCx) is made at the gate circuit 4 and transmitted to a gate of the open and close switch 7.

The open and close switch 7 is controlled such that it becomes a turn-off state completely while the connection changing switch 6 is connected and performs the changing operation. Conversely, when the open and close switch 7 is turned on, all of L1 to L3 of FIG. 2 are set to the L level to cause the connection changing switch 6 to become the turn off state, and current paths from the outputs of the column control circuits to the data lines are blocked. In this state, if the control line 17 is set to the H level, the TFTs (T11 to TN) of all of the columns of the open and close switch 7 become ON, and a summation of the current outputs of the column control circuits 1 is retrieved as Iout from the common terminal 8 to outside of the display panel.

In order to turn on the open and close switch 7 to output a summation current, and perform the correction of the video signal, a current detection period is provided in a period other than the period in which a normal display operation is performed. The current detection period may be provided immediately after a power of the apparatus is turned on, and in a period before the display is still not started, or may be provided in an interval of the display period, and in a vertical retrace time in which the row control circuit does not perform the row selection.

In the current detection period, CCx is set to the H level, all of T1 to TN (N is the number of the columns) of the open and close switch 7 are turned ON, and simultaneously, all of L1 to L3 are set to the L level and all of the connection changing switches M11 to M33 of all of the columns are turned OFF. At this point, the output terminals of the column control circuits 1 are separated from the data lines, and all of the output currents flow to the common terminal 8.

In this state, one group consisting of the three column control circuits Gm1, Gm2 and Gm3 is selected, the video signals corresponding to a maximum luminance (white signals) are supplied to the above described column control circuits, and the video signals corresponding to a minimum luminance (black signals) are supplied to the column control circuits 1 of the other groups. Although this video signal may be transmitted from outside as the video signal Video, this video signal may be generated in the correction circuit 32.

At this point, the current data signals corresponding to the maximum luminance are outputted from the three column control circuits of the selected group, and the current data signals corresponding to the minimum luminance, that is, zero currents are outputted from the remaining column control circuits. Although the latter must be true zero by nature, very little current has occurred as an offset in actual column control circuits. However, since this is a constant value, when a deviation from an average value is considered, this is cancelled and its effect disappears.

As to the video signals to be transmitted to the column control circuits in the above described current detection period, since it is sufficient if it is possible to distinguish one group of column control circuit outputs, it is not necessarily transmit the maximum luminance signal to the above described column, and a signal of a less luminance than the maximum may be transmitted. Also, the signals of the groups other than the above described group may not be the minimum luminance signal. However, the same signal must be given even when the other group is selected.

The currents from the column control circuits flow out of the common terminal 8 as a sum of the output currents of all of the column control circuits, and it is guided by the current detection circuit 10, and then a current value is detected. This detection is repeated sequentially for each group.

The correction circuit 11 stores the current detected for each column and calculates the average value for all of the groups. In an amount of a difference between the detected current of each column and the average value divided by the average value (hereinafter referred to as “deviation”), the zero currents are cancelled and an output current characteristic of the column control circuits of each group appear directly. Therefore, it is possible to correct the video signal based on this amount. In other words, the deviation of the ith group is set to xi and a correction factor is calculated and stored as follows:

ki=1+xi.

Also, an amount of a video signal amplitude v multiplied by ki, that is, kiv, is transmitted to the column control circuits as a corrected video signal amplitude.

The characteristic of each group is fixed unless it varies due to a surrounding environment such as a temperature or it varies over time. If the characteristic has been previously measured only once, by correcting the amplitude of the video signal depending on a result of the measurement, it is possible to eliminate the variation among the groups. At this time, the correction factor is preferably stored in a ROM (read only memory). Then the open and close switch 7 and the current detection circuit 10 become unnecessary.

### 6. Variation Example

FIG. 5 is a diagram showing another configuration example of the connection changing switch 6 and the open and close switch 7 of the above described embodiment.

In the above described embodiment, the current detection has been performed by turning off all of the TFTs (M11 to M33) of the connection changing switch 6 and turning on all of the TFTs of the open and close switch 7. In this variation example, the connection changing switch 6 is configured with a first switch 61 and a second switch 62. The first switch 61 is provided at a position which is nearer to the column control circuits 1 than a branch point 71 of the open and close switch 7, that is, the drain terminals of TFT switches T1, T2, . . . , and changes over the connections of the column control circuits 1 and data line extended wirings 14r′ to 14b′. The second switch 62 is provided at a position which is nearer to the data lines 14 than the branch point 71, and is configured with TFT switches S1, S2, . . . SN (N is the number of the columns), in which the drain terminals are connected to the data line extended wiring 14r′ and the like and the source terminals are connected to the data lines 14. The second switch 62 opens and closes the connections of the column control circuits 1 and the data lines 14.

A circuit of the first switch 61 is the same as that of the connection changing switch 6 of FIG. 2. There is no operation in which all of the control signals L1 to L3 become the L level, and instead of it, a control signal which is inverse logical with respect to a gate control signal CCx of the open and close switch 7:

CCy(= C̅C̅x)

is inputted in the gate terminals of the TFT switches S1, S2, . . . of the second switch 62. Accordingly, the second switch 62 is turned off in the current detection period, and the connections of the column control circuits 1 and the data lines 14 are blocked.

### 7. Other Circuits

Hereinafter, contents of the pixel circuit 2 and the column control circuit 1 will be briefly described. The features of the present embodiment as described above do not depend on details of these circuits.

FIG. 6 is an example of the pixel circuit 2 including the EL element.

Scan signals P1 and P2 are row selection signals transmitted through the scan line 20 from the row control circuit 5. A current data signal Idata is inputted through the data line 14 from the column control circuit 1. An EL element EL emits light with the current from a P type driving TFT (M1). Among other TFTs, M2 and M4 are P type TFTs, M3 is a N type TFT.

When the row control circuit 5 has not selected the row, an L level signal is inputted in the scan signal P1, an H level signal is inputted in P2, and it is in a state where the transistor M2 is OFF, M3 is OFF and M4 is ON. In this state, the current data signal is not inputted in the pixel circuit 2.

When the row has been selected, the High level signal is inputted in P1, the Low level signal is inputted in P2, the transistors M2 and M3 become ON, and M4 becomes OFF. In this state, the current data Idata is inputted, and a voltage depending on the current data occurs in a capacitor C1 placed between the gate terminal of M1 and a power electric potential VCC.

Next, the H level signal is inputted in P2, M2 becomes the OFF state, subsequently the L level signal is inputted in P1, M3 becomes OFF, and M4 becomes ON. Accordingly, the current depending on the voltage which has occurred in C1 is supplied in the EL element EL, and the EL element emits light.

FIG. 7 is a circuit example of the column control circuit 1. The column control circuit 1 is configured with a sampling unit 41 and a voltage-current conversion unit 42. The sampling unit 41 is configured with two systems of circuits including a set consisting of circuit elements of odd numbers such as M1, M3 and the like, and a set consisting of circuit elements of even numbers such as M2, M4 and the like. The sampling unit 41 performs the sampling alternately with sampling pulses Spa and Spb, which are interchanged and inputted for each one horizontal sync Hsync. A control signal 15 from the gate circuit 4 is transmitted to the horizontal shift register 3, and occurrence and alternation of the sampling pulses Spa and Spb of the two systems are controlled.

When the sampling pulse Spa of the odd number system is inputted, M1 and M3 become ON, and the Video signal and a reference signal REF are stored in capacitors C1 and C3 respectively. When the sampling of one horizontal line has been completed, a control signal P11 (16 of FIG. 1) is inputted from the gate circuit 4, M3 and M7 become ON, and sampling data V(data) and V(ref) are transmitted to the voltage-current conversion unit. In this period, since the video signal Video of the next line comes in, the similar operation is performed by the circuit of the even number system, with the sampling pulse Spb of the even number system and another control signal P12 (shown with the same reference numeral 16 in FIG. 1) from the gate circuit 4.

In the voltage-current conversion unit 42, the current adjusted by VB is supplied from M11, and divided and flows into M12 and M13 depending on a difference between V(data) and V(ref). Differential outputs outputted from the respective drains are formed by differential amplifiers M19 and M20 of the next phase, and linearity with respect to the input is increased. The current of M20 is outputted as a current i(data) by current mirror circuits of M14 and M15.

In the above description, although the EL display apparatus has been described as the example, the display apparatus of the present invention is not limited to it. The display apparatus of the present invention is applicable to a current driven type display apparatus such as PDP (Plasma Display Panel), FED (Field Emission Display) and the like.

It is possible to use the display apparatus of the present invention to configure an information display apparatus. As the information display apparatus to which the present invention has been applied, a cellular phone, a portable computer, a still camera, a video camera and the like can be listed. Alternatively, a complex apparatus including those functions may be configured. In the case of the cellular phone, the apparatus is configured to include an antenna as an information input unit. In the case of a personal digital assistance (PDA) or the portable computer, the information input unit is configured to include an interface unit with respect to a network. In the case of the still camera or a movie camera, the information input unit is configured to include a sensor unit of CCD, CMOS and the like.

### EXAMPLE

An example of using the present invention to a digital still camera will be described below.

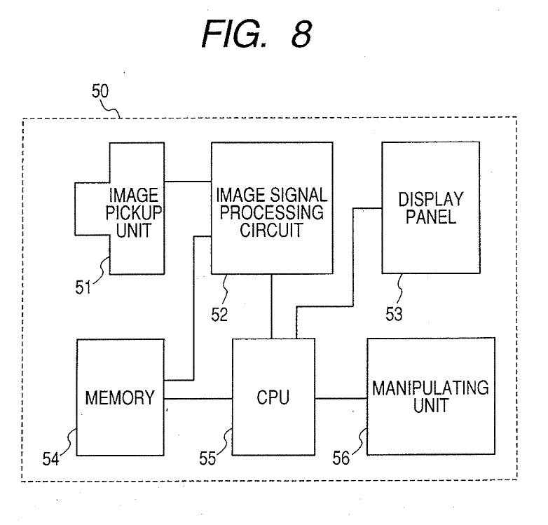

FIG. 8 is a system block diagram of the digital still camera of this example. In this figure, reference numeral 50 denotes the digital still camera, reference numeral 51 denotes an image pick-up unit, reference numeral 52 denotes an image signal processing circuit, and reference numeral 53 denotes a display panel, which is the display apparatus of the present invention and is the same as the display panel 100 of FIG. 1. Reference numeral 54 denotes a memory, reference numeral 55 denotes a CPU, and reference numeral 56 denotes a manipulating unit.

In FIG. 8, an image which has been shot by the image pick-up unit 51, or an image which has been stored in the memory 54 is signal-processed by the image signal processing circuit 52, and the image can be viewed at the display panel 53. The CPU 55 controls the image pick-up unit 51, the memory 54, the image signal processing circuit 52 and the like according to an input from the manipulating unit 56, and performs shooting, recording, playing and displaying, which are suitable for a situation. The CPU 55 includes the current detection circuit 33 and the correction circuit 32 of FIG. 1. Also, the CPU 55 performs a process of changing over the parallel video signals of RGB three colors to be transmitted to the display panel, in synchronization with the operation of the connection changing switch of the present invention.

This application claims the benefit of Japanese Patent Application No. 2005-297639, filed Oct. 12, 2005, which is hereby incorporated by reference herein in its entirety.

1. A display apparatus comprising:
a matrix display area in which display elements and pixel circuits for driving said display elements are arranged in a row direction and a column direction;
a row control circuit provided for each row of said matrix display area, for selecting said pixel circuit at said row;
a column control circuit provided for each column of said matrix display area, for receiving an input signal and generating and outputting a current data signal depending on said input signal; and
a data line provided for each column of said matrix display area, for conveying said current data signal outputted from said column control circuit, to the pixel circuit selected by said row control circuit,
wherein said column control circuit and said data line configures a plurality of groups having the same number of column control circuits and data lines as one group, and said display apparatus further comprises:
a connection changing switch provided for each of said groups, for connecting said column control circuits and said data lines in said group in a one-to-one manner in which they can be changed or disconnecting said column control circuits and said data lines in said group; and
correction means for receiving a video signal, correcting said received video signal for each group of said column control circuits and outputting the corrected video signal as the input signal of said column control circuit.

2. The display apparatus according to claim 1, wherein said connection changing switch changes the connections of said column control circuits and said data lines, in synchronization with a row selection by said row control circuit.

3. The display apparatus according to claim 1, wherein said connection changing switch changes the connections of said column control circuits and said data lines periodically.

4. The display apparatus according to claim 1, wherein said correction means comprises:
an open and close switch for branching a current path from said column control circuit to said data line and connecting the current path to a terminal which is common to all columns;
a current detection circuit connected to said terminal which is common to all columns, for detecting a sum of currents outputted from said column control circuits; and
a correction circuit for correcting said video signal based on an output from said current detection circuit.

5. The display apparatus according to claim 4, wherein said connection changing switch consists of:
a first switch provided at a position which is nearer to said column control circuit than a point of said branch, for connecting said column control circuits and said data lines in said group in a one-to-one manner in which they can be changed; and
a second switch provided at a position which is nearer to said data line than the point of said branch, for opening and closing the connections of said column control circuits and said data lines.

6. The display apparatus according to claim 4, wherein operations are performed, the operations comprising:
turning off said connection changing switch and turning on said open and close switch in a non-display period in which said row control circuit does not select the pixel circuit at any row, and for each of said groups, inputting the input signal for distinguishing said group from other groups into said column control circuits and also detecting the sum of the currents by said current detection circuit; and
turning on said connection changing switch and turning off said open and close switch in a display period in which said row control circuit has selected the pixel circuit at any row, and based on the sum of the currents detected for each of said groups in said non-display period, correcting said video signal by said correction circuit.

7. The display apparatus according to claim 6, wherein said operation of correcting the video signal by the correction circuit is an operation comprising:
calculating a deviation of the sum of the currents detected for each of said groups from an average of the sums of the currents over all of said groups, and based on said deviation, modulating an amplitude of said video signal by said correction circuit.

8. The display apparatus according to claim 1, wherein the video signal is a set of parallel signals prepared to be supplied to predetermined data lines of each group, and the input signal of the column control circuits of each of said groups is another set of parallel signals of the same number as the number of the column control circuits in the group, said input signal has been made from said video signal by an inverse permutation with respect to the connections of said column control signals and said data lines.

9. The display apparatus according to claim 8, wherein said video signal is a set of parallel signals of respective colors, and said data lines in a group are provided for respective columns of light emitting elements of said respective colors.
